(19) United States
(12) Patent Application Publication
(10) Pub. No.: US 2015/0378530 A1
(43) Pub. Date: Dec. 31, 2015

(54) COMMAND SURFACE DRILL-IN CONTROL

(71) Applicant: MICROSOFT TECHNOLOGY LICENSING, LLC, Redmond, WA (US)

(72) Inventors: Edward Layne, JR., Seattle, WA (US); Il Yeo, Bellevue, WA (US); Timothy Long, Woodinville, WA (US)

(21) Appl. No.: 14/746,795

(22) Filed: Jun. 22, 2015

Related U.S. Application Data
(60) Provisional application No. 62/018,468, filed on Jun. 27, 2014.

(51) Int. Cl. G06F 3/0482; G06F 3/0488; G06F 3/0484

(52) U.S. Cl. CPC G06F 3/0482; G06F 3/04842; G06F 3/04883; G06F 3/04886

(57) ABSTRACT

An original command surface, such as a callout or pane, provides drill-in navigation functionality for reusing on-screen real estate when displaying a drilled-in command surface that presents additional commands or content related to a selected command button. Drill-in navigation can be effectuated by a command surface drill-in control having push and pop functionality that can be placed inside of various types of command surfaces. In response to execution of the command button, the push functionality pushes new content to a command surface stack that includes original content displayed by the original command surface. The drilled-in command surface displays the new content and a back button. In response to execution of the back button, the pop functionality removes the new content from the command surface stack causing the original content to be redisplayed by the original command surface.

### CROSS-REFERENCE TO RELATED APPLICATIONS

This patent application claims priority to U.S. provisional patent application Ser. No. 62/018,468 titled “COMMAND SURFACE DRILL-IN CONTROL” which was filed on Jun. 27, 2014 and which is expressly incorporated herein by reference in its entirety.

### BACKGROUND

A callout or drop-down menu can be displayed when a toolbar command is clicked. Additional commands that are related to a specific callout command often are shown using a submenu anchored to the callout.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

An original command surface, such as a callout or pane, provides drill-in navigation functionality for reusing on-screen real estate when displaying a drilled-in command surface that presents additional commands or content related to a selected command button. Drill-in navigation can be effectuated by a command surface drill-in control having push and pop functionality that can be placed inside of various types of command surfaces. In response to execution of the command button, the push functionality pushes new content to a command surface stack that includes original content displayed by the original command surface. The drilled-in command surface displays the new content and a back button. In response to execution of the back button, the pop functionality removes the new content from the command surface stack causing the original content to be redisplayed by the original command surface.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 illustrates an embodiment of an exemplary architecture in accordance with aspects of the described subject matter.

FIGS. 2A-C illustrate exemplary implementations of command surface drill-in control in accordance with aspects of the described subject matter.

FIG. 3 illustrates an exemplary state diagram in accordance with aspects of the described subject matter.

FIG. 4 illustrates an exemplary command surface stack in accordance with aspects of the described subject matter.

FIG. 5 illustrates an exemplary transition from an original callout to a drilled-in callout in accordance with aspects of the described subject matter.

FIG. 6 illustrates an embodiment of an exemplary process in accordance with aspects of the described subject matter.

FIG. 7 illustrates an embodiment of an exemplary operating environment that can implement aspects of the described subject matter.

FIG. 8 illustrates an embodiment of an exemplary mobile computing device that can implement aspects of the described subject matter.

### DETAILED DESCRIPTION

The detailed description provided below in connection with the appended drawings is intended as a description of examples and is not intended to represent the only forms in which the present examples may be constructed or utilized. The description sets forth functions of the examples and sequences of steps for constructing and operating the examples. However, the same or equivalent functions and sequences may be accomplished by different examples.

References to “one embodiment,” “an embodiment,” “an example embodiment,” “one implementation,” “an implementation,” “one example,” “an example” and the like, indicate that the described embodiment, implementation or example may include a particular feature, structure or characteristic, but every embodiment, implementation or example may not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic may be implemented in connection with other embodiments, implementations or examples whether or not explicitly described.

Numerous specific details are set forth in order to provide a thorough understanding of one or more aspects of the described subject matter. It is to be appreciated, however, that such aspects may be practiced without these specific details. While certain components are shown in block diagram form to describe one or more aspects, it is to be understood that functionality performed by a single component may be performed by multiple components. Similarly, a single component may be configured to perform functionality described as being performed by multiple components.

Various aspects of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

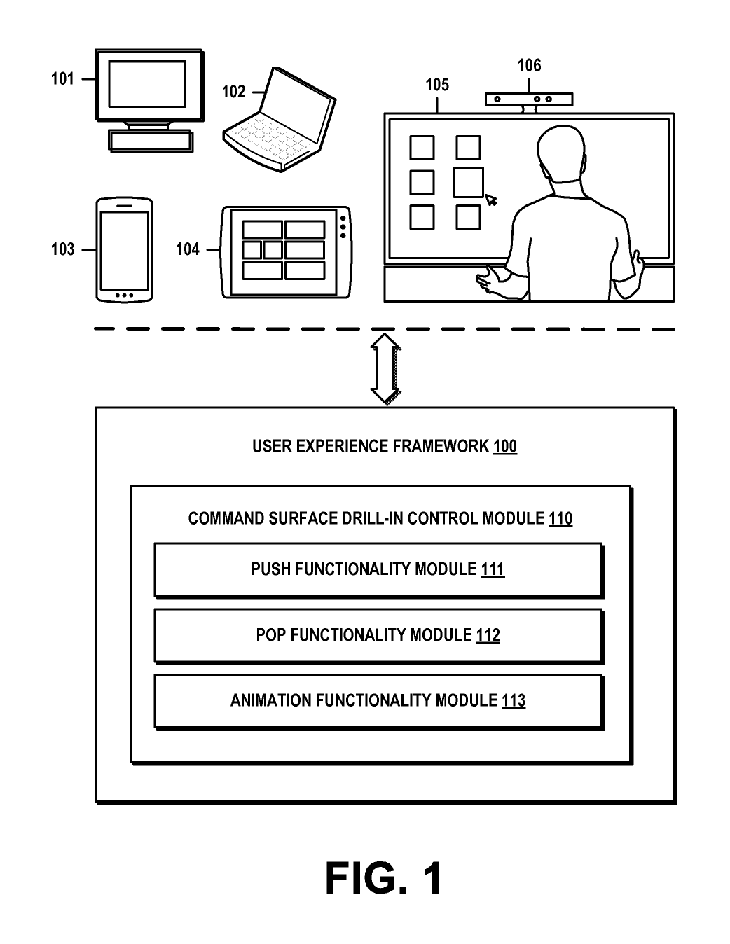

FIG. 1 illustrates a user experience framework 100 as an embodiment of an exemplary architecture in accordance with aspects of the described subject matter. It is to be appreciated that user experience framework 100, or portions thereof, can be implemented by various computing devices and can be implemented by software, hardware, firmware or a combination thereof in various embodiments.

Implementations of user experience framework 100 are described in the context of a computing device and/or a computer system configured to perform various steps, methods, and/or functionality in accordance with aspects of the described subject matter. It is to be appreciated that a computer system can be implemented by one or more computing devices. Implementations of user experience framework 100 also are described in the context of “computer-executable instructions” that are executed to perform various steps, methods, and/or functionality in accordance with aspects of the described subject matter.

In general, a computing device and/or computer system can include one or more processors and storage devices (e.g., memory and disk drives) as well as various input devices, output devices, communication interfaces, and/or other types of devices. A computing device and/or computer system also can include a combination of hardware and software. It can be appreciated that various types of computer-readable storage media can be part of a computing device and/or computer system. As used herein, the terms “computer-readable storage media” and “computer-readable storage medium” do not mean and unequivocally exclude a propagated signal, a modulated data signal, a carrier wave, or any other type of transitory computer-readable medium. In various implementations, a computing device and/or computer system can include a processor configured to execute computer-executable instructions and a computer-readable storage medium (e.g., memory and/or additional hardware storage) storing computer-executable instructions configured to perform various steps, methods, and/or functionality in accordance with aspects of the described subject matter.

Computer-executable instructions can be embodied and/or implemented in various ways such as by a computer program (e.g., client program and/or server program), a software application (e.g., client application and/or server application), software code, application code, source code, executable files, executable components, program modules, routines, application programming interfaces (APIs), functions, methods, objects, properties, data structures, data types, and/or the like. Computer-executable instructions can be stored on one or more computer-readable storage media and can be executed by one or more processors, computing devices, and/or computer systems to perform particular tasks or implement particular data types in accordance with aspects of the described subject matter.

User experience framework 100 can be implemented by one or more computing devices, such as client devices 101-106. Client device 101 is shown as a personal computer (PC). Client device 102 is shown as a laptop computer. Client device 103 is shown as a smartphone. Client device 104 is shown as a tablet device. Client device 105 and client device 106 are shown as a television and a media device (e.g., media and/or gaming console, set-top box, etc.). It is to be understood that the number and types of client devices 101-106 are provided for purposes of illustration. User experience framework 100 also can be implemented by one or more computing devices of a computer system configured to provide server-hosted, cloud-based, and/or online services in accordance with aspects of the described subject matter.

In implementations where user-related data is utilized, user experience framework 100 and/or computing devices (e.g., client devices 101-106, computing devices of a computer system, etc.) that provide and/or support user experience framework 100 can employ a variety of mechanisms in the interests of user privacy and information protection. Such mechanisms may include, without limitation: requiring authorization to monitor, collect, or report data; enabling users to opt in and opt out of data monitoring, collecting, and reporting; employing privacy rules to prevent certain data from being monitored, collected, or reported; providing functionality for anonymizing, truncating, or obfuscating sensitive data which is permitted to be monitored, collected, or reported; employing data retention policies for protecting and purging data; and/or other suitable mechanisms for protecting user privacy.

As shown, user experience framework 100 can be implemented by one or more computer program modules configured for implementing a command surface drill-in control having push functionality, pop functionality, and animation functionality. Computer program modules of user experience framework 100 can be implemented by computer-executable instructions that are stored on one or more computer-readable storage media and that are executed to perform various steps, methods, and/or functionality in accordance with aspects of the described subject matter. While such computer program modules are shown in block diagram form to describe certain functionality, it is to be understood that the functionality performed by a single computer program module may be performed by multiple computer program modules and that a single computer program module may be configured to perform functionality described as being performed by multiple computer program modules.

Command surface drill-in control module 110 can be configured to implement a command surface drill-in control for a user interface (UI) command surface. A command surface drill-in control can be implemented for various UI command surfaces including, without limitation: callouts, panes, on-object UIs, controls, flyouts, boxes, menu surfaces, pop-ups, pop-overs, and the like. The command surface drill-in control can be implemented for UI surfaces that are responsive to various types of user input including, without limitation: touch input (e.g., taps, swipes, gestures, etc.), mouse input, keyboard (physical or virtual) input, pen input, and/or other types of user input in accordance with the described subject matter.

A command surface, such as a callout or pane, can display a set of commands. The command surface can provide drill-in navigation functionality that allows a user to view additional commands or content related to a command while reusing on-screen real estate. A command surface can provide an on-screen element, such as a command button, that can be clicked or tapped to execute a drill-in navigation event. In response to the click or tap, original content of the command surface can be replaced by new content that is related to the selected on-screen element. Drill-in navigation functionality can be effectuated by a stand-alone command surface drill-in control having push and pop functions that can be placed inside of various types of command surfaces. The command surface drill-in control can be utilized in user interfaces provided on desktop, touchscreen, and/or mobile devices and can be implemented across various form factors, architectures, and/or applications.

A command surface can display a set of commands and can be invoked in various ways. In some scenarios, a command surface can be invoked as a callout when a command button in another user interface surface (e.g., ribbon or toolbar) is clicked or tapped. A command surface also can be invoked by a press-and-hold command, a right-click command, a Shift+F10 command, and so forth. In some implementations, a command surface can be invoked automatically in response to insertion pointer placement or object selection in certain scenarios.

Within the set of commands displayed by a command surface, a specific command can be associated with additional commands Such additional commands can be displayed to a user in response to the user clicking or tapping a button for the specific command. When implemented by various touchscreen devices (e.g., tablets, phones, etc.), command surfaces can be much more space-constrained than when implemented on a desktop device. A command surface drill-in control can be utilized such that additional commands and content can be presented via a drilled-in command surface that reuses on-screen real estate occupied by an original command surface.

The command surface drill-in control can provide an original command surface with drill-in navigation functionality for allowing a user to view additional commands or content related to a command in the original command surface via a drilled-in command surface that reuses on-screen real estate. The drill-in navigation functionality can replace original content with new content such that the drilled-in command surface can reuse the same on-screen real estate occupied by the original command surface and occlude less on-screen real estate than would the combination of the original command surface (e.g., callout) and an anchored submenu.

In some scenarios, when a certain type of UI surface is presented to a user, an application may require the user to explicitly dismiss the UI surface from the screen by clicking an “X” or “Close” button. However, for various applications where touch is a primary mode of interface, it is often preferable to “light dismiss” certain UI surfaces from the screen whenever the user takes an action outside of the bounds of a given surface in many scenarios. In one implementation, a click or tap outside the bounds of a displayed (original and/or drilled-in) command surface will dismiss the displayed command surface.

Push functionality module 111 can be configured to implement push functionality (e.g., code, methods, functions, etc.) for a command surface drill-in control. The command surface drill-in control can include drill-in or push functionality for displaying new content that replaces original content displayed by a command surface. The command surface drill-in control can implement a push function or method and associate or hook the push function or method to a command displayed by a command surface. In response to a user executing the command, the command surface drill-in control can execute a drill-in navigation event or push action to show the new content.

An application and/or developer can specify a given button or control of a command surface that should invoke a drill-in navigation event and/or a push action. An application and/or developer can specify how many levels of drill-in are permitted. In some implementations, the command surface drill-in tool can define a maximum number of command surfaces (e.g., no more than three) that can be tied together via drill-in navigation.

Pop functionality module 112 can be configured to implement pop functionality (e.g., code, methods, functions, etc.) for a command surface drill-in control. The command surface drill-in control can include drill-out or pop functionality for returning to original content displayed by a command surface. The command surface drill-in control can implement a back button to be displayed by a command surface after drill-in navigation has occurred. The command surface drill-in control can implement a pop function or method and associate or hook the pop function or method to the back button. In response to the user executing the back button command, the command surface drill-in control can execute a drill-out navigation event or pop action to return to the original content.

The command surface drill-in control can implement a back button in a command surface, such as a callout or pane. In one implementation, the back button is placed at the upper left of the callout or pane. A drill-out navigation event can be invoked in response to the user clicking or tapping the back button. A drill-out navigation event also can be invoked in response to the user pressing backspace (hard or soft keyboard) assuming focus is not in an editable control. Upon drill-out navigation, focus can return to where it was on the callout prior to the original drill-in. For example, when the user lands on content of the previous callout, focus can return to the command button that was invoked to cause the drill-in navigation.

A command surface can display a title. In some implementations, the command surface drill-in control can implement the title to be displayed upon drill-in navigation. A title section of a command surface can be disabled, and a title section of the command surface drill-in control can be used instead. The title section of the command surface drill-in control can implement a back button. An application can pass a title (e.g., name associated with a command) to the command surface drill-in control. In response to the user clicking or tapping a command button that invokes drill-in navigation, the content and title of the command surface can be replaced by new content related to the selected command button. A new title associated with the selected button can be displayed upon drill-in navigation, and a back button can be placed (e.g., implemented by the command surface drill-in control) to the left of the new title. The new title and the back button can be associated or hooked so that the user can click or tap the back button or the new title to return to the previous (or original) callout and/or content. Upon drill-out navigation, the content and title of the callout can return to the prior content in the callout stack. When the user taps on the back button, the command surface will drill-out, and the content of the drilled-in command surface can be replaced with the content of the previous command surface.

Upon drill-in navigation, an application can pass new content (e.g., XAML content) that can be placed in the drilled-in callout. The new content can be provided by the application and/or from various types of data sources. The new content can include various types of content but generally will be closely tied to the command that invoked the drill-in functionality to avoid introducing complex navigation or nesting. The new content can serve as a launching point to a contextual UI. A contextual UI can include a UI surface that is contextually relevant to the user interaction and provided within the current application and/or by a different application.

Animation functionality module 113 can be configured to implement animation functionality (e.g., code, methods, functions, etc.) for a command surface drill-in control. The command surface drill-in control can implement animation functionality for displaying content upon drill-in navigation and/or drill-out navigation. The command surface drill-in control can handle the animation of each control placed inside of it. In one implementation, the presentation of the drilled-in command surface can be animated to present content for the drilled-in command surface as sliding in from the right. The presentation of returning to the original command surface from the drilled-in command surface can be animated to present the content of the original command surface as sliding in from the left. The same animations can be applied to the title and content sections of the command surface.

In one embodiment, a command surface can be configured to display content contained at a top position of a command surface stack. The command surface can implement a command surface drill-in control that includes push functionality for adding new content to the top position of the command surface stack and pop functionality for removing content from the top position of the command surface stack. An original command surface can display original content contained at the top position of the command surface stack. The command surface drill-in control can associate a push function or method with a command displayed by the original command surface. In response to a user executing the command, a drill-in navigation event can be invoked to push new content to the top position of the command surface stack for display within a drilled-in command surface. The command surface drill-in control can associate a pop function or method with a back button displayed by the drilled-in command surface. In response to the user executing a back button command, a drill-out navigation event can be invoked to pop content from the top position of the command surface stack so that the original content is displayed again.

In one embodiment, the command surface drill-in control can be implemented as a stand-alone control (e.g., XAML container) that can be placed inside of various types of command surfaces including callouts and panes. Drill-in navigation functionality can be beneficial for different types of command surfaces in a variety of scenarios. When implemented as a stand-alone control, the command surface drill-in control can be reusable across various command surfaces and applications. As such, providing drill-in navigation functionality within a command surface, across various command surfaces, within an application, and/or across various applications can be facilitated and consistently implemented. In one embodiment, the command surface drill-in control is embedded as a container (e.g., code container, tagged container, etc.) implemented within a container of a command surface. For example, the command surface drill-in control can be implemented as a container of executable code within a container of code for a callout, a pane, or other UI surface in accordance with the described subject matter.

The following is an exemplary implementation of embedding a drill-in container within one or more command surface containers.

<callout>

<drill-in control>
</drill-in control>

</callout>
<pane>

<drill-in control>
</drill-in control>

</pane>

In some implementations, an application can place content inside of a command surface's content section and hook up to a drill-in or push event. In some implementations, certain sections (e.g., title and/or content sections) can be placed inside of the command surface drill-in control.

In various implementations, the command surface drill-in control can be configured for use by different types of command surfaces and can be utilized to facilitate and/or simply application development. For example, the command surface drill-in control can implement: a push method, a back button, and a pop method associated with or hooked to the back button. A developer can implement the command surface drill-in control within a command surface that is configured to respond to execution of a toolbar command by presenting content contained at a top position of a command surface stack. The content can implement a command button to be presented in the original command surface. The developer can associate the command button with the push method of the command surface drill-in control and can specify application or other content to be presented by a drilled-in command surface. The command surface drill-in control thus can be configured to push new content from an application or other data source to the top position of the command surface stack in response to execution of the command button presented in the original command surface. The command surface can then display the new content when contained at the top position of the command surface stack. The display of the new content can reuse on-screen real estate used to display the original content. The command surface drill-in control can be configured to disable a title section of the original command surface and present a new title section that includes the back button and a new title within the command surface. In response to execution of the back button presented in the command surface, the new content can be popped from the top position of the command surface stack causing the command surface to redisplay the original content.

The command surface drill-in control can support keyboard navigation. In one implementation, after a drill-in navigation event, a user can return to the content of the previous callout by hitting backspace to execute a drill-out navigation event. After a drill-in navigation event, a user can hit the escape (Esc) key to close the callout. The back button can be included in the tab stop ordering of the callout such that: if a user hits Shift+Tab after a drill-in navigation event, the back button can be focused.

The command surface drill-in control can be implemented for various applications including, but not limited to: word processing applications, spreadsheet applications, slideshow presentation applications, note taking applications, email applications, text messaging applications, and other types of applications that enable users to select, author, and/or edit content. For a particular application, the command surface drill-in control and/or parts thereof can be implemented to provide drill-in navigation functionality for various UI surfaces provided by the application.

The command surface drill-in control can be implemented to customize, standardize, modify, and/or define drill-in navigation behavior for one or more applications, windows, UI surfaces, and/or users. The command surface drill-in control can provide an application with the flexibility to customize drill-in navigation functionality for various scenarios (e.g., use cases, modes, etc.) and/or enable consistent drill-in navigation functionality across various applications. As such, an application can determine and/or decide how clicks and/or taps are to be handled and can employ the command surface drill-in control to effectuate desired drill-in navigation behavior.

The command surface drill-in control and/or parts thereof can be implemented by or for an application that operates in various modes (e.g., reading mode, editing mode, slideshow mode) or orientations (e.g., portrait view, landscape view, a 50/50 view) and can be designed to provide consistent functionality and/or behavior in multiple modes and/or multiple orientations. The command surface drill-in control and/or parts thereof can be implemented by or for an application that operates across various touchscreen devices (e.g., desktop, laptop, tablet, mobile phone), form factors, and/or input types and can be designed to provide consistent functionality and/or behavior across multiple touchscreen devices, multiple form factors, and/or multiple input types. The command surface drill-in control and/or parts thereof can be implemented by or for an application that operates across various operating systems (e.g., a Microsoft® Windows® operating system, a Google® Android™ operating system, an Apple iOS™ operating system) and can be designed to provide consistent functionality and/or behavior across multiple operating systems. The command surface drill-in control and/or parts thereof can be implemented by or for different applications that employ UI surfaces and can be designed to provide consistent functionality and/or behavior across different applications.

The command surface drill-in control can advantageously provide a consistent, understandable user experience so that users can be confident of receiving a desired response when a command surface is presented. The command surface drill-in control also can provide a consistent user experience within an application, across various UI surface types, across various input types, and across various applications. Additionally, the command surface drill-in control can minimize the number of clicks or taps required to complete and action while minimizing accidental invocation of on-screen elements so that user feel safe and comfortable when providing touch input to an application. The command surface drill-in control also can maintain user efficiency by enabling consistent functionality and/or behavior across desktop and mobile implementations. The command surface drill-in control can allow users to easily and confidently navigate a command surface using touch or keyboard input in a manner by clicking a button to change content of a current context and clicking a back button to return to previous content.

The following exemplary embodiments, implementations, examples, and scenarios are provided to further illustrate aspects the described subject matter. It is to be understood that the following exemplary embodiments, implementations, examples, and scenarios are provided for purposes of illustration and not limitation.

### Exemplary Use Case Scenarios

In one exemplary use case scenario, a user is reviewing an essay on her slate that she has been working on in her local coffee shop and wants to highlight a few pieces to indicate that they need closer revision when she gets back to her laptop at her apartment. The user selects a piece of text, and then searches the ribbon for the highlight button. The user doesn't find it initially, so she taps on the button that she has learned shows more ribbon commands, and a callout appears. The user finds and taps on the highlight button, and the callout's contents “drill-in” to show the highlighter color choices. The user chooses the color yellow, sees that the text has been highlighted, and then dismisses the callout.

In another exemplary use case scenario, a user is working on a calculus project, and he is using a spreadsheet application to make a graph from data. The user selects the appropriate range of cells, and inserts a graph from the ribbon. The user then decides that he wants to change the graph type from “Line” to “Bar”, so he opens a pane that contains graphing options. The user selects “Graph Type”, upon which the pane drills in to show the different types of graphs. The user selects “Bar”, and approves of the change. The user drills back out to the graph options, and this time selects “Graph Color”. The user finds a combination of gold and white that he thinks looks great.

### Exemplary Implementations of Command Surface Drill-in Control

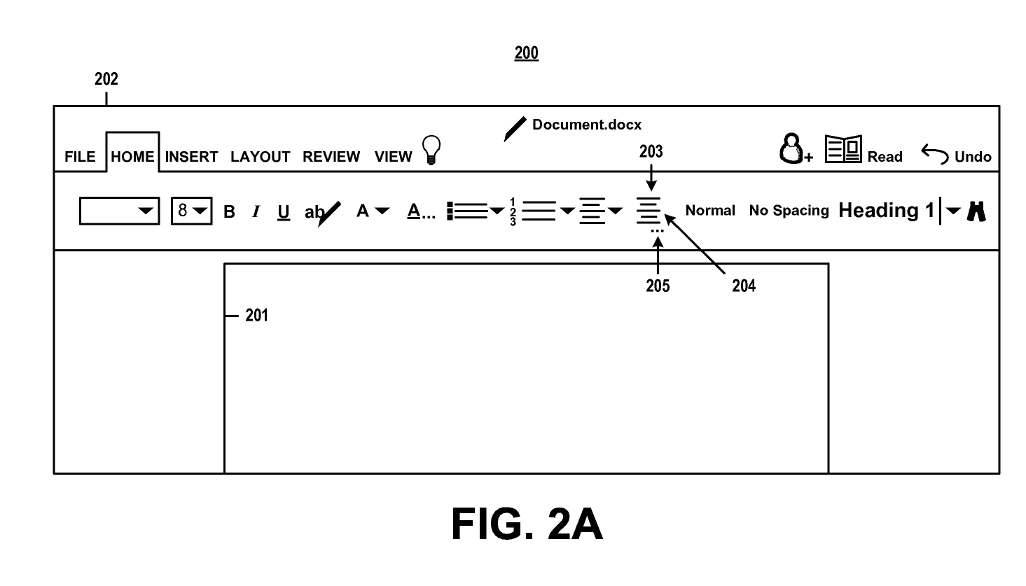

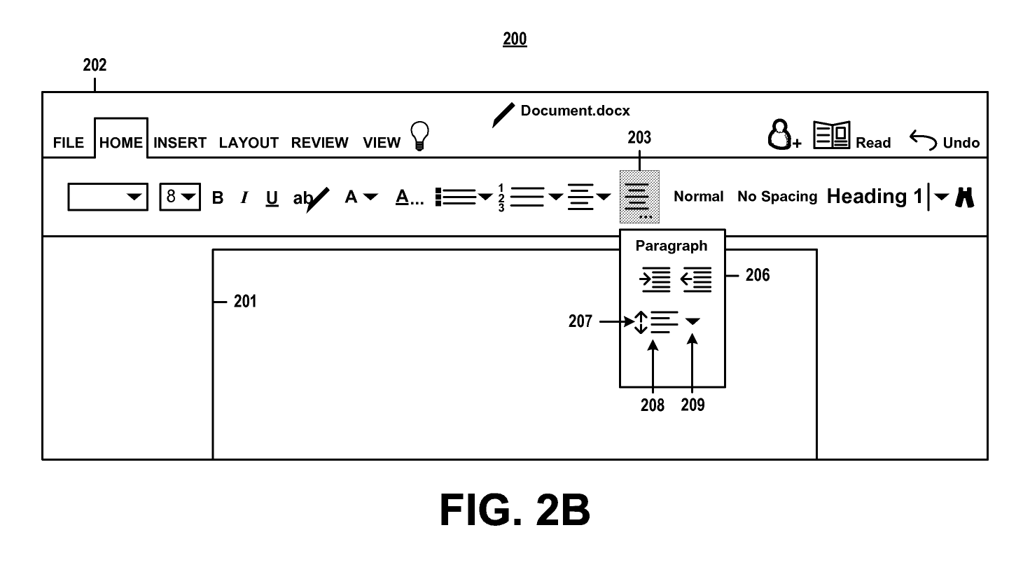

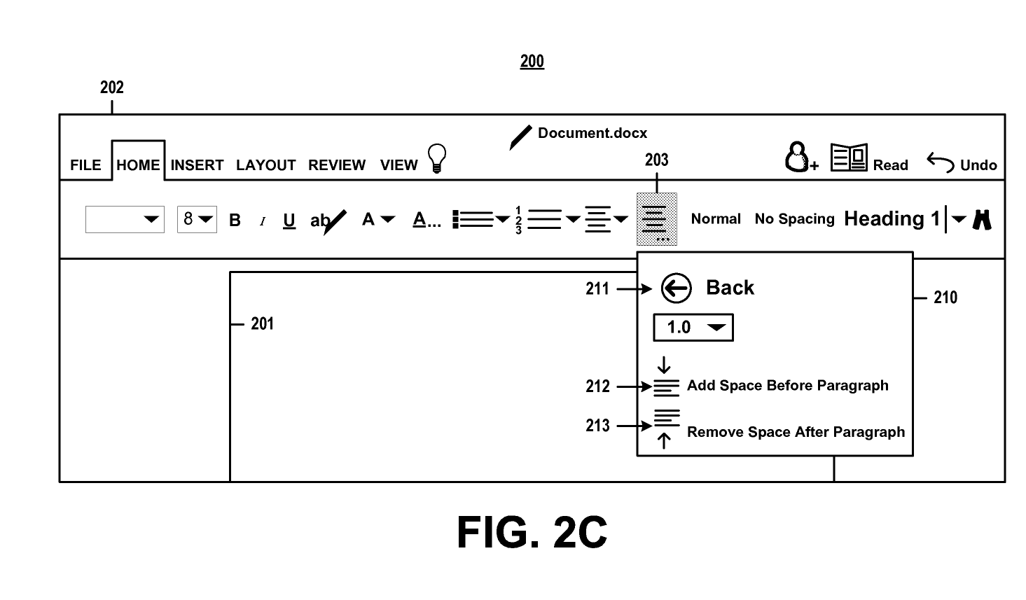

FIGS. 2A-C illustrate exemplary implementations of command surface drill-in control for an application user interface 200 executing on a touch screen computing device. A document 201 is displayed within application user interface 200 as shown in FIG. 2A. Application user interface 200 includes a ribbon 202 implemented by a tabbed set of toolbars. A command button 203 (e.g., paragraph command button) in ribbon 202 displays an icon 204 that includes a symbol for the command and an indicator 205 (e.g., a text character such as an ellipsis, triangle, etc.) to indicate or represent that user is able to access nested commands or functions.

When application user interface 200 is displayed, as shown in FIG. 2A, the user can tap into ribbon 202 on a command button 203. In response to the tap into ribbon 202 on command button 203, command button 203 can be shaded and an original command surface 206 implemented as a callout can be displayed, as shown in FIG. 2B. A command button 207 (e.g., paragraph spacing command button) in original command surface 206 displays an icon 208 that includes a symbol for the command and an indicator 209 (e.g., a text character such as an ellipsis, triangle, etc.) to indicate or represent that user is able to access nested commands or functions. Original command surface 206 can implement light dismiss behavior such that: if the user taps outside of the bounds of original command surface 206, original command surface 206 will be dismissed returning application user interface 200 to the state shown in FIG. 2A.

When application user interface 200 is displayed, as shown in FIG. 2B, the user can tap into original command surface 206 on command button 207 (e.g., paragraph spacing command button). In response to the tap into original command surface 206 on command button 207, a drilled-in command surface 210 can be displayed, as shown in FIG. 2C. Drilled-in command surface 210 can include one or more additional commands, such as command 212 (e.g., add space before paragraph) and command 213 (e.g., remove space after paragraph), and/or other types of content that are related to command button 207 in original command surface 206. In one implementation, the presentation of drilled-in command surface 210 can be animated to present content for drilled-in command surface 210 as sliding in from the right. Drilled-in command surface 210 can implement light dismiss behavior such that: if the user taps outside of the bounds of drilled-in command surface 210, drilled-in command surface 210 will be dismissed returning application user interface 200 to the state shown in FIG. 2A and without displaying original command surface 206.

When application user interface 200 is displayed, as shown in FIG. 2C, the user can tap into drilled-in command surface 210 on a back button 211. In response to the tap into drilled-in command surface 210 on back button 211, the application user interface 200 can return to displaying original command surface 206, as shown in FIG. 2B. In one implementation, the presentation of returning to original command surface 206 from drilled-in command surface 210 can be animated to present the content of original command surface 206 as sliding in from the left. Again, original command surface 206 can implement light dismiss behavior such that: if the user taps outside of the bounds of original command surface 206, original command surface 206 will be dismissed returning application user interface 200 to the state shown in FIG. 2A.

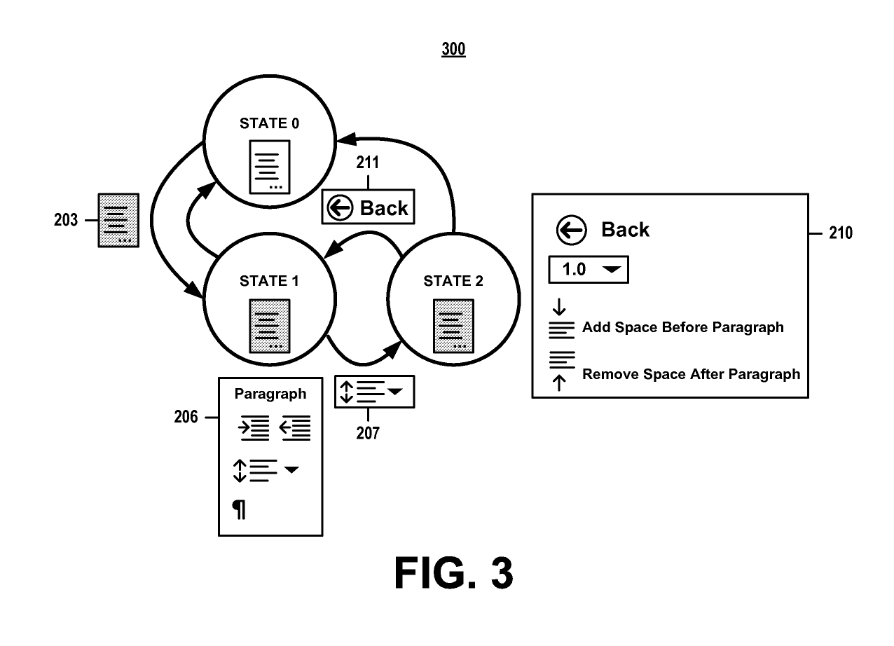

With continuing reference to the foregoing figures, FIG. 3 illustrates a state diagram 300 as an embodiment of an exemplary state diagram in accordance with aspects of the described subject matter. State diagram 300 corresponds to various conditions of an application user interface such as application user interface 200. State 0 represents a condition prior to the display of a certain command surface such as original command surface 206. State 1 represents a condition where original command surface 206 is displayed within application user interface 200. State 2 represents a condition where drilled-in command surface 210 is displayed within application user interface 200.

A transition from State 0 to State 1 can be effectuated in response to a user clicking or tapping command button 203 (e.g., paragraph command button) in ribbon 202 displayed by application user interface 200. A transition to State 0 from State 1 can be effectuated in response to the user clicking or tapping outside the bounds of original command surface 206.

A transition from State 1 to State 2 can be effectuated in response to the user clicking or tapping command button 207 (e.g., paragraph spacing command button) displayed within original command surface 206. A transition to return to State 1 from State 2 can be effectuated in response to the user clicking or tapping back button 211 displayed within drilled-in command surface 210. A transition from State 2 to State 0 can be effectuated in response to the user clicking or tapping outside the bounds of drilled-in command surface 210.

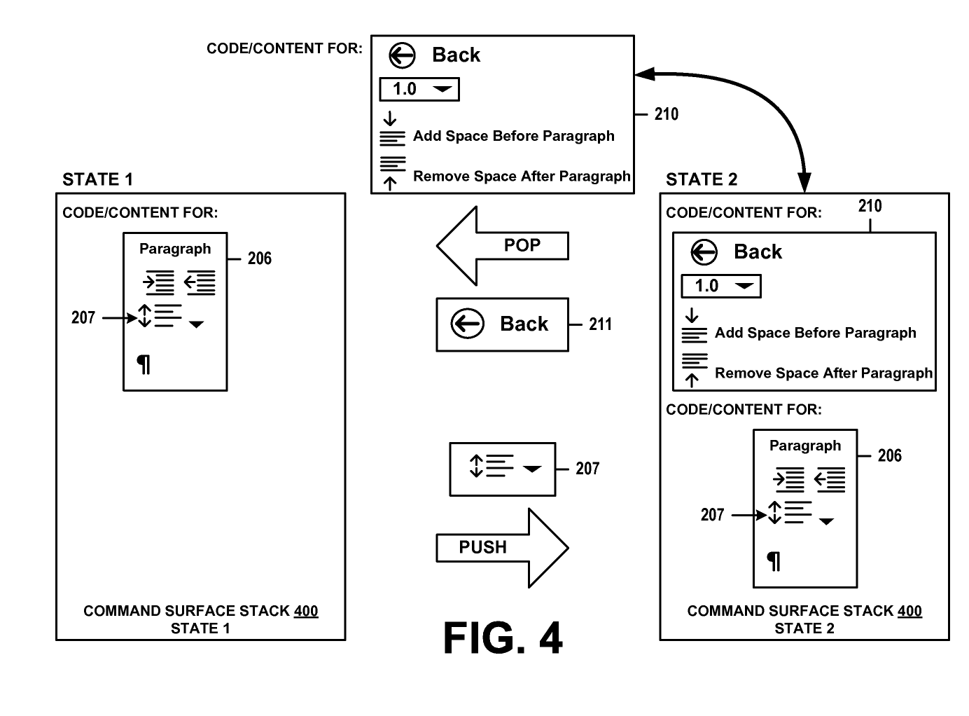

With continuing reference to the foregoing figures, FIG. 4 illustrates a command surface stack 400 as an exemplary command surface stack in accordance with aspects of the described subject matter. State 1 and State 2 illustrate various conditions of command surface (e.g., callout) stack 400. Command surface stack 400 can be implemented as a last-in-first-out stack. Command surface stack 400 can be associated with a command surface that is provided in response to a user clicking or tapping a command button in a ribbon displayed by a user interface (e.g., application user interface 200).

Command surface stack 400 can contain original content at the top of the stack (State 1). The original content contained at the top of command surface stack 400 can be presented within original command surface 206 (e.g., FIG. 2B). In some implementations, original command surface 206 can be a first state or version of a command surface. In some implementations, original command surface 206 can be a first or parent command surface.

In response to the user clicking or tapping command button 207 (e.g., paragraph spacing command button) displayed within original command surface 206 (e.g., FIG. 2B), a command surface drill-in control can execute a push action. The push action can cause new or drilled-in content to be pushed into command surface stack 400. After execution of the push action, command surface stack 400 can contain the new or drilled-in content at the top of the stack over the original content (State 2). The new or drilled-in content at the top of the command surface stack can be displayed by drilled-in command surface 210 (e.g., FIG. 2C). In some implementations, drilled-in command surface 210 can be a second state or version of a command surface. In some implementations, drilled-in command surface 210 can be a second or child command surface.

In response to the user clicking or tapping back button 211 displayed within drilled-in command surface 210 (e.g., FIG. 2C), a command surface drill-in control can execute a pop action. The pop action can cause content that was previously pushed into command surface stack 400 to be popped and removed from command surface stack 400. After execution of the pop action, command surface stack 400 again can contain the original content at the top of the stack (State 1).

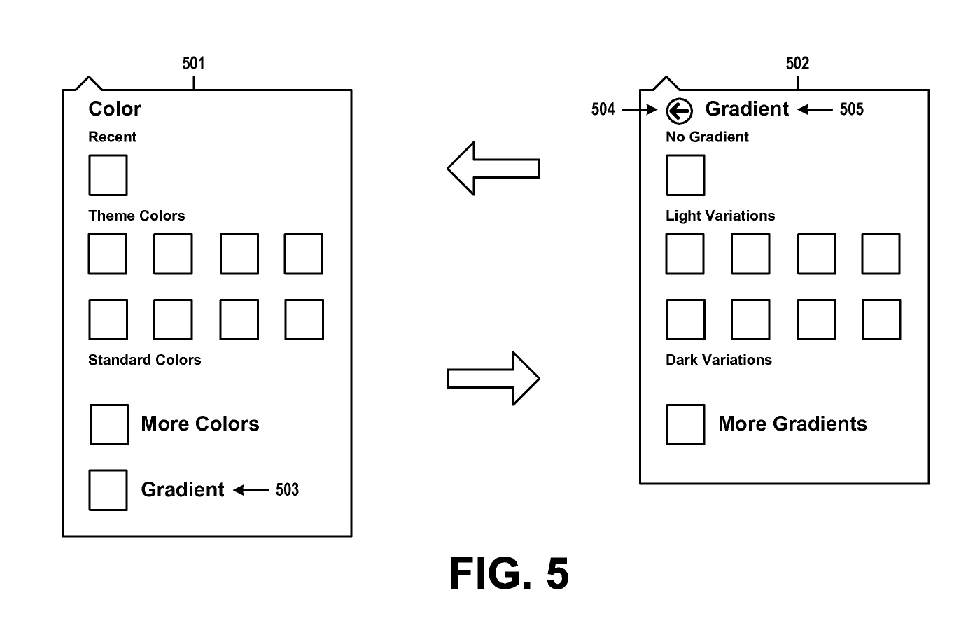

FIG. 5 illustrates an exemplary transition from an original callout 501 to a drilled-in callout 502 in accordance with aspects of the described subject matter. In response to the user tapping on “Gradient” command 503, original callout 501 employs drill-in navigation to replace an original set of content and commands with a new set of content and commands related to “Gradient” command 503. A back button 504 that is presented in proximity to a title 505 can allow the user to return to the previous set of commands. As shown, the drill-in navigation enables the reuse of on-screen real estate.

### Exemplary Process for Command Surface Drill-in Control

With continuing reference to the foregoing figures, an exemplary process is described below to further illustrate aspects of the described subject matter. It is to be understood that the following exemplary process is not intended to limit the described subject matter to particular implementations.

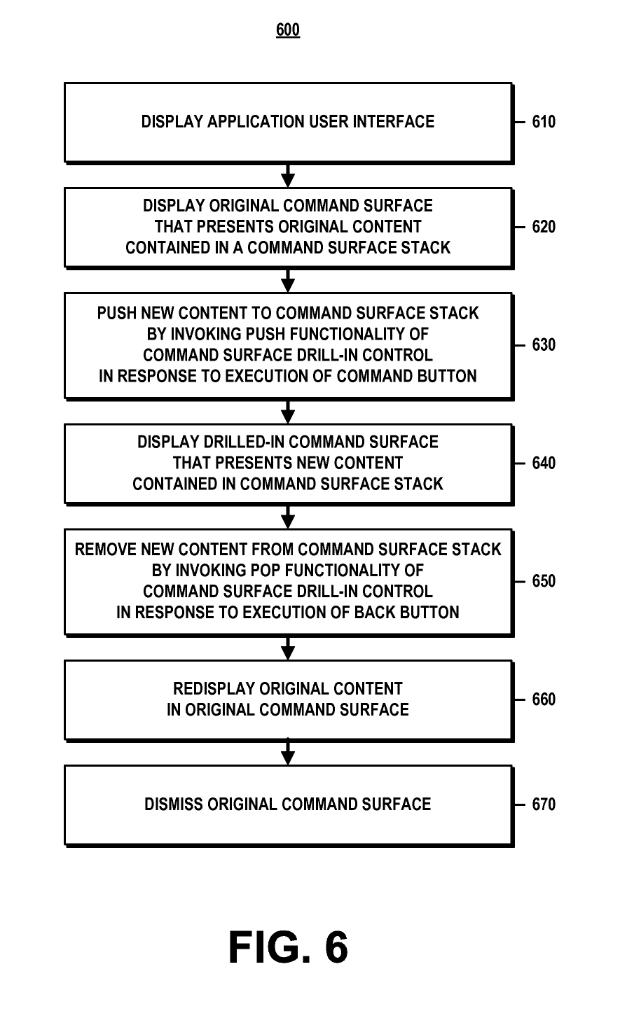

FIG. 6 illustrates a computer-implemented method 600 as an embodiment of an exemplary process for command surface drill-in control in accordance with aspects of the described subject matter. In various embodiments, computer-implemented method 600 can be performed by a computing device and/or a computer system including one or more computing devices. It is to be appreciated that computer-implemented method 600, or portions thereof, can be performed by various computing devices, computer systems, components, and/or computer-executable instructions stored on one more computer-readable storage media.

At 610, a computing device can display an application user interface. For example, a computing device such as one of client devices 101-106 can display application user interface 200. Application user interface 200 can present document 201 and ribbon 202 implemented as a tabbed set of toolbars. Ribbon 202 can include a toolbar command button such as command button 203 (e.g., paragraph command button).

At 620, the computing device and/or application user interface can display an original command surface that presents original content contained in a command surface stack. For example, original command surface 206 can be displayed in response to touch input that executes command button 203 in application user interface 200. Original command surface 206 can present original content contained in a command surface stack such a command surface stack 400. The original content can include a command button 207 that is presented in original command surface 206. Original command surface 206 can implement a command surface drill-in control, such as command surface drill-in control module 110, including push functionality for drill-in navigation and pop functionality for drill-out navigation. The push functionality can be associated with command button 207. The command surface drill-in control can implement back button 211 and associate the pop functionality with back button 211.

At 630, the computing device and/or application can push new content to the command surface stack by invoking the push functionality of the command surface drill-in control in response to execution of the command button presented in the original command surface. For example, execution of command button 207 in original command surface 206 can invoke the push functionality of the command surface drill-in control to push new content for drilled-in command surface 210 to command surface stack 400. Command surface stack can be implemented as is a last-in-first out stack, and invoking the push functionality of the command surface drill-in control can push the new content to a top position of command surface stack 400, which also includes the original content for original command surface 206.

At 640, the computing device and/or application user interface can display a drilled-in command surface that presents the new content contained in the command surface stack. For example, drilled-in command surface 210 is displayed in application user interface 200 and reuses on-screen real estate that was occupied by original command surface 206. Drilled-in command surface 210 presents back button 211 and additional commands (command 212, command 213, etc.) related to command button 207 in original command surface 206. The command surface drill-in control can include animation functionality to present the new content in drilled-in command surface 210 as sliding in from the right in response to execution of command button 207. In some implementations, the command surface drill-in control can be configured to disable a title section of the original command surface and present a new title section that includes back button and a new title to be displayed upon drill-in navigation.

At 650, the computing device and/or application can remove the new content from the command surface stack by invoking the pop functionality of the command surface drill-in control in response to execution of the back button presented in the drilled-in command surface. For example, execution of back button 211 in drilled-in command surface 210 can invoke the pop functionality of the command surface drill-in control to remove the new content from command surface stack 400. Command surface stack can be implemented as is a last-in-first out stack, and invoking the pop functionality of the command surface drill-in control can remove the new content from the top position of command surface stack 400, which also includes the original content for original command surface 206. Removing the new content from command surface stack 400 causes the original content to be redisplayed by original command surface 206.

At 660, the computing device and/or application user interface can redisplay the original content in the original command surface. For example, original command surface 206 can be redisplayed and presents the original content contained in command surface stack 400 in response to execution of back button 211. The command surface drill-in control can include animation functionality to redisplay original command surface 206 and present the original content as sliding in from the left in response to execution of back button 211.

At 670, the computing device and/or application user interface can dismiss the original command surface. For example, original command surface 206 can be implemented as a light dismiss UI surface that is dismissed in response to a click and/or touch input that is outside of original command surface 206.

### Exemplary Operating Environments

Aspects of the described subject matter can be implemented for and/or by various operating environments, computer networks, platforms, frameworks, computer architectures, and/or computing devices. Aspects of the described subject matter can be implemented by computer-executable instructions that can be executed by one or more computing devices, computer systems, and/or processors.

In its most basic configuration, a computing device and/or computer system can include at least one processing unit (e.g., single-processor units, multi-processor units, single-core units, and/or multi-core units) and memory. Depending on the exact configuration and type of computer system or computing device, the memory implemented by a computing device and/or computer system can be volatile (e.g., random access memory (RAM)), non-volatile (e.g., read-only memory (ROM), flash memory, and the like), or a combination thereof.

A computing device and/or computer system can have additional features and/or functionality. For example, a computing device and/or computer system can include hardware such as additional storage (e.g., removable and/or non-removable) including, but not limited to: solid state, magnetic, optical disk, or tape.

A computing device and/or computer system typically can include or can access a variety of computer-readable media. For instance, computer-readable media can embody computer-executable instructions for execution by a computing device and/or a computer system. Computer readable media can be any available media that can be accessed by a computing device and/or a computer system and includes both volatile and non-volatile media, and removable and non-removable media. As used herein, the term “computer-readable media” includes computer-readable storage media and communication media.

The term “computer-readable storage media” as used herein includes volatile and nonvolatile, removable and non-removable media for storage of information such as computer-executable instructions, data structures, program modules, or other data. Examples of computer-readable storage media include, but are not limited to: memory storage devices such as RAM, ROM, electrically erasable program read-only memory (EEPROM), semiconductor memories, dynamic memory (e.g., dynamic random access memory (DRAM), synchronous dynamic random access memory (SDRAM), double data rate synchronous dynamic random-access memory (DDR SDRAM), etc.), integrated circuits, solid-state drives, flash memory (e.g., NAN-based flash memory), memory chips, memory cards, memory sticks, thumb drives, and the like; optical storage media such as Blu-ray discs, digital video discs (DVDs), compact discs (CDs), CD-ROM, optical disc cartridges, and the like; magnetic storage media including hard disk drives, floppy disks, flexible disks, magnetic cassettes, magnetic tape, and the like; and other types of computer-readable storage devices. It can be appreciated that various types of computer-readable storage media (e.g., memory and additional hardware storage) can be part of a computing device and/or a computer system. As used herein, the terms “computer-readable storage media” and “computer-readable storage medium” do not mean and unequivocally exclude a propagated signal, a modulated data signal, a carrier wave, or any other type of transitory computer-readable medium.

Communication media typically embodies computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

In various embodiments, aspects the described subject matter can be implemented by computer-executable instructions stored on one or more computer-readable storage media. Computer-executable instructions can be implemented using any various types of suitable programming and/or markup languages such as: Extensible Application Markup Language (XAML), XML, XBL HTML, XHTML, XSLT, XMLHttpRequestObject, CSS, Document Object Model (DOM), Java®, JavaScript, JavaScript Object Notation (JSON), Jscript, ECMAScript, Ajax, Flash®, Silverlight™, Visual Basic® (VB), VBScript, PHP, ASP, Shockwave®, Python, Perl®, C, Objective-C, C++, C#/.net, and/or others.

A computing device and/or computer system can include various input devices, output devices, communication interfaces, and/or other types of devices. Exemplary input devices include, without limitation: a user interface, a keyboard/keypad, a touch screen, a touch pad, a pen, a mouse, a trackball, a remote control, a game controller, a camera, a barcode reader, a microphone or other voice input device, a video input device, laser range finder, a motion sensing device, a gesture detection device, and/or other type of input mechanism and/or device. A computing device can provide a Natural User Interface (NUI) that enables a user to interact with the computing device in a “natural” manner, free from artificial constraints imposed by input devices such as mice, keyboards, remote controls, and the like. Examples of NUI technologies include, without limitation: voice and/or speech recognition, touch and/or stylus recognition, motion and/or gesture recognition both on screen and adjacent to a screen using accelerometers, gyroscopes and/or depth cameras (e.g., stereoscopic or time-of-flight camera systems, infrared camera systems, RGB camera systems and/or combination thereof), head and eye tracking, gaze tracking, facial recognition, 3D displays, immersive augmented reality and virtual reality systems, technologies for sensing brain activity using electric field sensing electrodes (EEG and related methods), intention and/or goal understanding, and machine intelligence.

A computing device can be configured to receive and respond to input in various ways depending upon implementation. Responses can be presented in various forms including, for example: presenting a user interface, outputting an object such as an image, a video, a multimedia object, a document, and/or other type of object; outputting a text response; providing a link associated with responsive content; outputting a computer-generated voice response or other audio; or other type of visual and/or audio presentation of a response. Exemplary output devices include, without limitation: a display, a projector, a speaker, a printer, and/or other type of output mechanism and/or device.

A computing device and/or computer system can include one or more communication interfaces that allow communication between and among other computing devices and/or computer systems. Communication interfaces can be used in the context of network communication between and among various computing devices and/or computer systems. Communication interfaces can allow a computing device and/or computer system to communicate with other devices, other computer systems, web services (e.g., an affiliated web service, a third-party web service, a remote web service, and the like), web service applications, and/or information sources (e.g. an affiliated information source, a third-party information source, a remote information source, and the like). As such communication interfaces can be used in the context of accessing, obtaining data from, and/or cooperating with various types of resources.

Communication interfaces also can be used in the context of distributing computer-executable instructions over a network or combination of networks. For example, computer-executable instructions can be combined or distributed utilizing remote computers and storage devices. A local or terminal computer can access a remote computer or remote storage device and download a computer program or one or more parts of the computer program for execution. It also can be appreciated that the execution of computer-executable instructions can be distributed by executing some instructions at a local terminal and executing some instructions at a remote computer.

A computing device can be implemented by a mobile computing device such as: a mobile phone (e.g., a cellular phone, a smart phone such as a Microsoft® Windows® phone, an Apple iPhone, a BlackBerry® phone, a phone implementing a Google® Android™ operating system, a phone implementing a Linux® operating system, or other type of phone implementing a mobile operating system), a tablet computer (e.g., a Microsoft® Surface® device, an Apple iPad™, a Samsung Galaxy Note® Pro, or other type of tablet device), a laptop computer, a notebook computer, a netbook computer, a personal digital assistant (PDA), a portable media player, a handheld gaming console, a wearable computing device (e.g., a smart watch, a head-mounted device including smart glasses such as Google® Glass™, a wearable monitor, etc.), a personal navigation device, a vehicle computer (e.g., an on-board navigation system), a camera, or other type of mobile device.

A computing device can be implemented by a stationary computing device such as: a desktop computer, a personal computer, a server computer, an entertainment system device, a media player, a media system or console, a video-game system or console, a multipurpose system or console (e.g., a combined multimedia and video-game system or console such as a Microsoft® Xbox® system or console, a Sony® PlayStation® system or console, a Nintendo® system or console, or other type of multipurpose game system or console), a set-top box, an appliance (e.g., a television, a refrigerator, a cooking appliance, etc.), or other type of stationary computing device.

A computing device also can be implemented by other types of processor-based computing devices including digital signal processors, field-programmable gate arrays (FPGAs), program- and application-specific integrated circuits (PASIC/ASICs), program- and application-specific standard products (PSSP/ASSPs), a system-on-a-chip (SoC), complex programmable logic devices (CPLDs), and the like.

A computing device can include and/or run one or more computer programs implemented, for example, by software, firmware, hardware, logic, and/or circuitry of the computing device. Computer programs can be distributed to and/or installed on a computing device in various ways. For instance, computer programs can be pre-installed on a computing device by an original equipment manufacturer (OEM), installed on a computing device as part of installation of another computer program, downloaded from an application store and installed on a computing device, distributed and/or installed by a system administrator using an enterprise network management tool, and distributed and/or installed in various other ways depending upon the implementation.

Computer programs implemented by a computing device can include one or more operating systems. Exemplary operating systems include, without limitation: a Microsoft® operating system (e.g., a Microsoft® Windows® operating system), a Google® operating system (e.g., a Google® Chrome OS™ operating system or a Google® Android™ operating system), an Apple operating system (e.g., a Mac OS® or an Apple iOS™ operating system), an open source operating system, or any other operating system suitable for running on a mobile, stationary, and/or processor-based computing device.

Computer programs implemented by a computing device can include one or more client applications. Exemplary client applications include, without limitation: a web browsing application, a communication application (e.g., a telephony application, an e-mail application, a text messaging application, an instant messaging application, a web conferencing application, and the like), a media application (e.g., a video application, a movie service application, a television service application, a music service application, an e-book application, a photo application, and the like), a calendar application, a file sharing application, a personal assistant or other type of conversational application, a game application, a graphics application, a shopping application, a payment application, a social media application, a social networking application, a news application, a sports application, a weather application, a mapping application, a navigation application, a travel application, a restaurants application, an entertainment application, a healthcare application, a lifestyle application, a reference application, a finance application, a business application, an education application, a productivity application (e.g., word processing application, a spreadsheet application, a slide show presentation application, a note-taking application, and the like), a security application, a tools application, a utility application, and/or any other type of application, application program, and/or app suitable for running on a mobile, stationary, and/or processor-based computing device.

Computer programs implemented by a computing device can include one or more server applications. Exemplary server applications include, without limitation: one or more server-hosted, cloud-based, and/or online applications associated with any of the various types of exemplary client applications described above; one or more server-hosted, cloud-based, and/or online versions of any of the various types of exemplary client applications described above; one or more applications configured to provide a web service, a web site, a web page, web content, and the like; one or more applications configured to provide and/or access an information source, data store, database, repository, and the like; and/or other type of application, application program, and/or app suitable for running on a server computer.

A computer system can be implemented by a computing device, such as a server computer, or by multiple computing devices configured to implement a service in which one or more suitably-configured computing devices perform one or more processing steps. A computer system can be implemented as a distributed computing system in which components are located on different computing devices that are connected to each other through network (e.g., wired and/or wireless) and/or other forms of direct and/or indirect connections. A computer system also can be implemented via a cloud-based architecture (e.g., public, private, or a combination thereof) in which services are delivered through shared datacenters. For instance, a computer system can be implemented by physical servers of a datacenter that provide shared computing and storage resources and that host virtual machines having various roles for performing different tasks in conjunction with providing cloud-based services. Exemplary virtual machine roles can include, without limitation: web server, front end server, application server, database server (e.g., SQL server), domain controller, domain name server, directory server, and/or other suitable machine roles. Some components of a computer system can be disposed within a cloud while other components are disposed outside of the cloud.

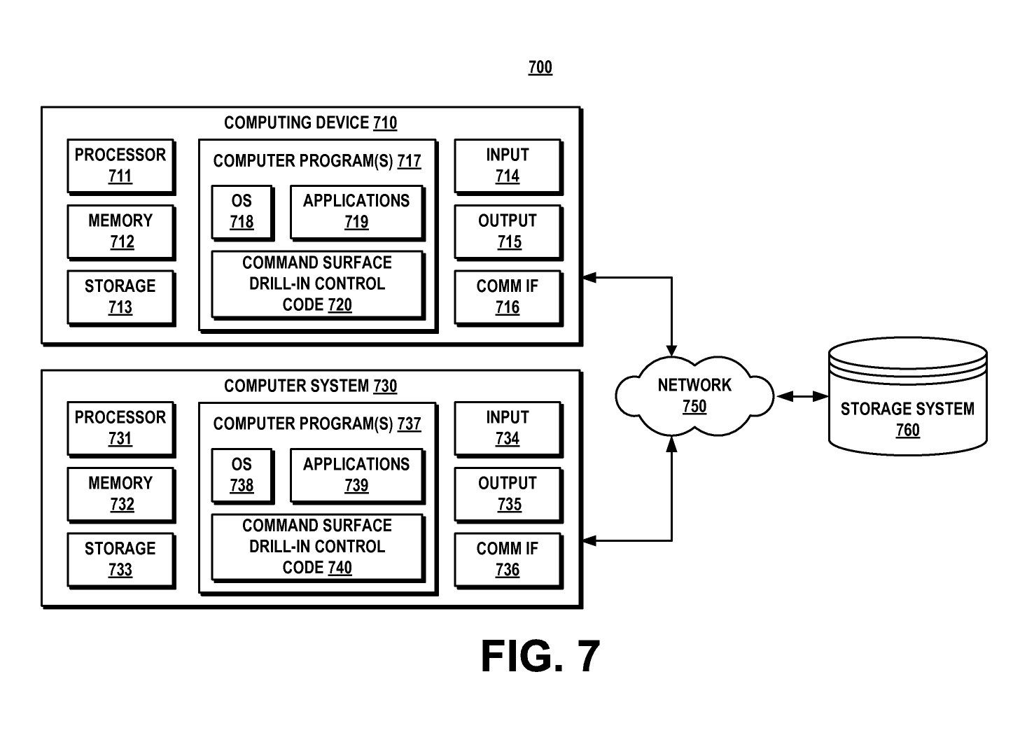

FIG. 7 illustrates an operating environment 700 as an embodiment of an exemplary operating environment that can implement aspects of the described subject matter. It is to be appreciated that operating environment 700 can be implemented by a client-server model and/or architecture as well as by other operating environment models and/or architectures in various embodiments.

Operating environment 700 includes a computing device 710, which can implement aspects of the described subject matter. Computing device 710 includes a processor 711 and memory 712. Computing device 710 also includes additional hardware storage 713. It is to be understood that computer-readable storage media includes memory 712 and hardware storage 713.

Computing device 710 includes input devices 714 and output devices 715. Input devices 714 can include one or more of the exemplary input devices described above and/or other type of input mechanism and/or device. Output devices 715 can include one or more of the exemplary output devices described above and/or other type of output mechanism and/or device.

Computing device 710 contains one or more communication interfaces 716 that allow computing device 710 to communicate with other computing devices and/or computer systems. Communication interfaces 716 also can be used in the context of distributing computer-executable instructions.

Computing device 710 can include and/or run one or more computer programs 717 implemented, for example, by software, firmware, hardware, logic, and/or circuitry of computing device 710. Computer programs 717 can include an operating system 718 implemented, for example, by one or more exemplary operating systems described above and/or other type of operating system suitable for running on computing device 710. Computer programs 717 can include one or more applications 719 implemented, for example, by one or more exemplary applications described above and/or other type of application suitable for running on computing device 710.

Computer programs 717 can be configured via one or more suitable interfaces (e.g., API or other data connection) to communicate and/or cooperate with one or more resources. Examples of resources include local computing resources of computing device 710 and/or remote computing resources such as server-hosted resources, cloud-based resources, online resources, remote data stores, remote databases, remote repositories, web services, web sites, web pages, web content, and/or other types of remote resources.

Computer programs 717 can implement computer-executable instructions that are stored in computer-readable storage media such as memory 712 or hardware storage 713, for example. Computer-executable instructions implemented by computer programs 717 can be configured to work in conjunction with, support, and/or enhance one or more of operating system 718 and applications 719. Computer-executable instructions implemented by computer programs 717 also can be configured to provide one or more separate and/or stand-alone services.

Computing device 710 and/or computer programs 717 can implement and/or perform various aspects of the described subject matter. As shown, computing device 710 and/or computer programs 717 can include command surface drill-in control code 720. In various embodiments, command surface drill-in control code 720 can include computer-executable instructions that are stored on a computer-readable storage medium and configured to implement one or more aspects of the described subject matter. By way of example, and without limitation, command surface drill-in control code 720 can be implemented by computing device 710 which, in turn, can represent one of client devices 101-106. By way of further example, and without limitation, command surface drill-in control code 720 can implement command surface drill-in control module 110, implement command surface drill-in control for one or more command surfaces of application user interface 200, transition among states of an application user interface in accordance with state diagram 300, implement command surface stack 400, present and transition between original callout 501 and drilled-in callout 502, and/or perform one or more aspects of computer-implemented method 600.

Operating environment 700 includes a computer system 730, which can implement aspects of the described subject matter. Computer system 730 can be implemented by one or more computing devices such as one or more server computers. Computer system 730 includes a processor 731 and memory 732. Computer system 730 also includes additional hardware storage 733. It is to be understood that computer-readable storage media includes memory 732 and hardware storage 733.

Computer system 730 includes input devices 734 and output devices 735. Input devices 734 can include one or more of the exemplary input devices described above and/or other type of input mechanism and/or device. Output devices 735 can include one or more of the exemplary output devices described above and/or other type of output mechanism and/or device.

Computer system 730 contains one or more communication interfaces 736 that allow computer system 730 to communicate with various computing devices (e.g., computing device 710) and/or other computer systems. Communication interfaces 736 also can be used in the context of distributing computer-executable instructions.

Computer system 730 can include and/or run one or more computer programs 737 implemented, for example, by software, firmware, hardware, logic, and/or circuitry of computer system 730. Computer programs 737 can include an operating system 738 implemented, for example, by one or more exemplary operating systems described above and/or other type of operating system suitable for running on computer system 730. Computer programs 737 can include one or more applications 739 implemented, for example, by one or more exemplary applications described above and/or other type of application suitable for running on computer system 730.

Computer programs 737 can be configured via one or more suitable interfaces (e.g., API or other data connection) to communicate and/or cooperate with one or more resources. Examples of resources include local computing resources of computer system 730 and/or remote computing resources such as server-hosted resources, cloud-based resources, online resources, remote data stores, remote databases, remote repositories, web services, web sites, web pages, web content, and/or other types of remote resources.

Computer programs 737 can implement computer-executable instructions that are stored in computer-readable storage media such as memory 732 or hardware storage 733, for example. Computer-executable instructions implemented by computer programs 737 can be configured to work in conjunction with, support, and/or enhance one or more of operating system 738 and applications 739. Computer-executable instructions implemented by computer programs 737 also can be configured to provide one or more separate and/or stand-alone services.

Computing system 730 and/or computer programs 737 can implement and/or perform various aspects of the described subject matter. As shown, computer system 730 and/or computer programs 737 can include command surface drill-in control code 740. In various embodiments, command surface drill-in control code 740 can include computer-executable instructions that are stored on a computer-readable storage medium and configured to implement one or more aspects of the described subject matter. By way of example, and without limitation, command surface drill-in control code 740 can implement command surface drill-in control module 110, implement command surface drill-in control for one or more command surfaces of application user interface 200, transition among states of an application user interface in accordance with state diagram 300, implement command surface stack 400, present and transition between original callout 501 and drilled-in callout 502, and/or perform one or more aspects of computer-implemented method 600.

Computing device 710 and computer system 730 can communicate over network 750, which can be implemented by any type of network or combination of networks suitable for providing communication between computing device 710 and computer system 730. Network 750 can include, for example and without limitation: a WAN such as the Internet, a LAN, a telephone network, a private network, a public network, a packet network, a circuit-switched network, a wired network, and/or a wireless network. Computing device 710 and computer system 730 can communicate over network 750 using various communication protocols and/or data types. One or more communication interfaces 716 of computing device 710 and one or more communication interfaces 736 of computer system 730 can be employed in the context of communicating over network 750.

Computing device 710 and/or computer system 730 can communicate with a storage system 760 over network 750. Alternatively or additionally, storage system 760 can be integrated with computing device 710 and/or computer system 730. Storage system 760 can be representative of various types of storage in accordance with the described subject matter. Storage system 760 can provide any suitable type of data storage for relational (e.g., SQL) and/or non-relational (e.g., NO-SQL) data using database storage, cloud storage, table storage, blob storage, file storage, queue storage, and/or other suitable type of storage mechanism. Storage system 760 can be implemented by one or more computing devices, such as a computer cluster in a datacenter, by virtual machines, and/or provided as a cloud-based storage service.

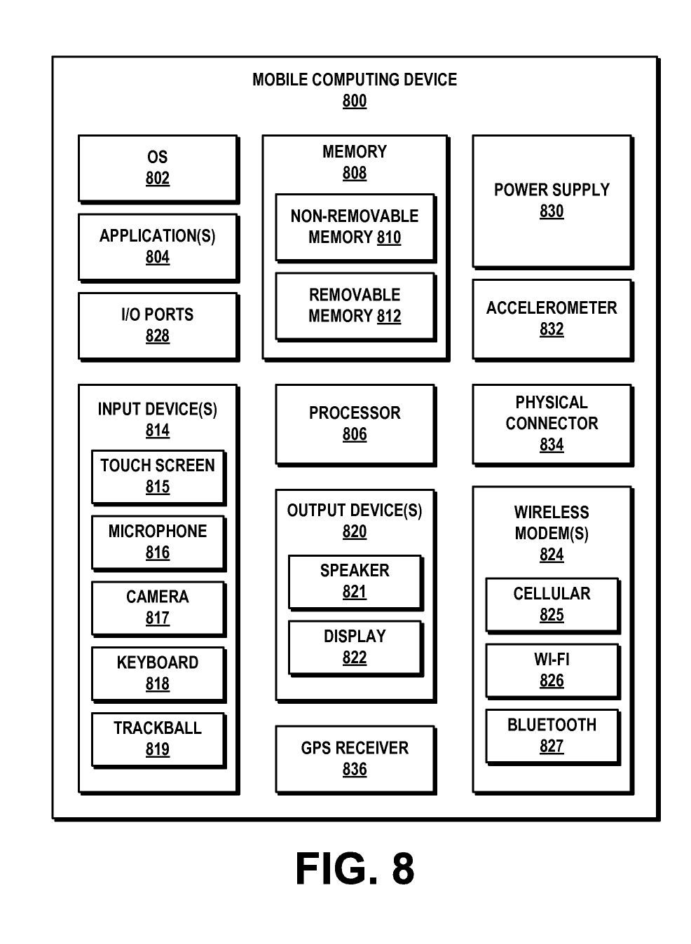

FIG. 8 illustrates a mobile computing device 800 as an embodiment of an exemplary mobile computing device that can implement aspects of the described subject matter. In various implementations, mobile computing device 800 can be an example of one or more of: client devices 102-104 and/or computing device 710.

As shown, mobile computing device 800 includes a variety of hardware and software components that can communicate with each other. Mobile computing device 800 can represent any of the various types of mobile computing device described herein and can allow wireless two-way communication over a network, such as one or more mobile communications networks (e.g., cellular and/or satellite network), a LAN, and/or a WAN.

Mobile computing device 800 can include an operating system 802 and various types of mobile application(s) 804. In some implementations, mobile application(s) 804 can include one or more client application(s) and/or components of command surface drill-in control code 720 (e.g., light dismissal management module 110).

Mobile computing device 800 can include a processor 806 (e.g., signal processor, microprocessor, ASIC, or other control and processing logic circuitry) for performing tasks such as: signal coding, data processing, input/output processing, power control, and/or other functions.

Mobile computing device 800 can include memory 808 implemented as non-removable memory 810 and/or removable memory 812. Non-removable memory 810 can include RAM, ROM, flash memory, a hard disk, or other memory device. Removable memory 812 can include flash memory, a Subscriber Identity Module (SIM) card, a “smart card” and/or other memory device.

Memory 808 can be used for storing data and/or code for running operating system 802 and/or mobile application(s) 804. Example data can include web pages, text, images, sound files, video data, or other data to be sent to and/or received from one or more network servers or other devices via one or more wired and/or wireless networks. Memory 808 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile computing device 800 can include and/or support one or more input device(s) 814, such as a touch screen 815, a microphone 816, a camera 817, a keyboard 818, a trackball 819, and other types of input devices (e.g., NUI device and the like). Touch screen 815 can be implemented, for example, using a capacitive touch screen and/or optical sensors to detect touch input. Mobile computing device 800 can include and/or support one or more output device(s) 820, such as a speaker 821, a display 822, and/or other types of output devices (e.g., piezoelectric or other haptic output devices). In some implementations, touch screen 815 and display 822 can be combined in a single input/output device.

Mobile computing device 800 can include wireless modem(s) 824 that can be coupled to antenna(s) (not shown) and can support two-way communications between processor 806 and external devices. Wireless modem(s) 824 can include a cellular modem 825 for communicating with a mobile communication network and/or other radio-based modems such as Wi-Fi modem 826 and/or Bluetooth modem 827. Typically, at least one of wireless modem(s) 824 is configured for: communication with one or more cellular networks, such as a GSM network for data and voice communications within a single cellular network; communication between cellular networks; or communication between mobile computing device 800 and a public switched telephone network (PSTN).

Mobile computing device 800 can further include at least one input/output port 828, a power supply 830, an accelerometer 832, a physical connector 834 (e.g., a USB port, IEEE 1394 (FireWire) port, RS-232 port, and the like), and/or a Global Positioning System (GPS) receiver 836 or other type of a satellite navigation system receiver. It can be appreciated the illustrated components of mobile computing device 800 are not required or all-inclusive, as various components can be omitted and other components can be included in various embodiments.

In various implementations, components of mobile computing device 800 can be configured to perform various operations in connection with aspects of the described subject matter. By way of example, and without limitation, mobile computing device 800 can implement command surface drill-in control module 110, implement command surface drill-in control for one or more command surfaces of application user interface 200, transition among states of an application user interface in accordance with state diagram 300, implement command surface stack 400, present and transition between original callout 501 and drilled-in callout 502, and/or perform one or more aspects of computer-implemented method 600. Computer-executable instructions for performing such operations can be stored in a computer-readable storage medium, such as memory 808 for instance, and can be executed by processor 806.

### Supported Aspects

The detailed description provided above in connection with the appended drawings explicitly describes and supports various aspects in accordance with the described subject matter. By way of illustration and not limitation, supported aspects include a computing device configured to provide navigation control in an application user interface, the computer system comprising: a processor configured to execute computer-executable instructions; and memory storing computer-executable instructions configured to: display an original command surface in response to execution of a command in the application user interface, the original command surface presenting original content contained in a command surface stack, the original content including a command button that is presented in the original command surface, the original command surface implementing a command surface drill-in control including push functionality for drill-in navigation and pop functionality for drill-out navigation; invoke the push functionality of the command surface drill-in control to push new content to the command surface stack in response to execution of the command button presented in the original command surface; display a drilled-in command surface that presents the new content contained in the command surface stack, wherein the drilled-in command surface presents a back button and reuses on-screen real estate that was occupied by the original command surface; invoke the pop functionality of the command surface drill-in control to remove the new content from the command surface stack in response to execution of the back button presented in the drilled-in command surface; and redisplay the original command surface that presents the original content.

Supported aspects include the forgoing computing device, wherein the command surface drill-in control associates the push functionality with the command button, implements the back button, and associates the pop functionality with the back button.

Supported aspects include any of the forgoing computing devices, wherein invoking the push functionality of the command surface drill-in control pushes the new content to a top position of the command surface stack; and invoking the pop functionality of the command surface drill-in control removes the new content from the top position of the command surface stack.

Supported aspects include any of the forgoing computing devices, wherein the command surface drill-in control is configured to: disable a title section of the original command surface; and present a new title section that includes the back button and a new title to be displayed upon drill-in navigation.

Supported aspects include any of the forgoing computing devices, wherein the command surface drill-in control includes animation functionality to present the new content in the drilled-in command surface as sliding in from the right in response to execution of the command button.

Supported aspects include any of the forgoing computing devices, wherein command surface drill-in control includes animation functionality to present the original content in the original command surface as sliding in from the left in response to execution of the back button.

Supported aspects include any of the forgoing computing devices, wherein the command in the application user interface is executed in response to touch input into a ribbon on a toolbar command button.

Supported aspects include any of the forgoing computing devices, wherein the new content includes one or more additional commands related to the command button in the original command surface.

Supported aspects include any of the forgoing computing devices, wherein the memory further stores computer-executable instructions configured to: dismiss the original command surface in response to touch input that is outside of the original command surface.

Supported aspects further include an apparatus, a system, a computer-readable storage medium, a computer-implemented method, and/or means for implementing any of the foregoing computing devices or portions thereof.

Supported aspects include a computer-implemented method performed by a computing device to provide navigation control in an application user interface, the computer-implemented method comprising: displaying, in the application user interface, an original command surface that presents original content contained in a command surface stack, the original content including a command button, the original command surface implementing a command surface drill-in control including: push functionality associated with the command button, a back button, and pop functionality associated with the back button; pushing new content to the command surface stack by invoking the push functionality of the command surface drill-in control in response to execution of the command button presented in the original command surface; displaying a drilled-in command surface that presents the new content contained in the command surface stack, the drilled-in command surface presenting the back button and reusing on-screen real estate that was occupied by the original command surface; removing the new content from the command surface stack by invoking the pop functionality of the command surface drill-in control in response to execution of the back button presented in the drilled-in command surface; and redisplaying the original content in the original command surface.

Supported aspects include the forgoing computer-implemented method, wherein the command surface stack is a last-in-first out stack.

Supported aspects include any of the forgoing computer-implemented methods, wherein the original command surface is initially displayed in response to execution of a command in a user interface surface of the application user interface.

Supported aspects include any of the forgoing computer-implemented methods, wherein the user interface surface is a ribbon comprising a tabbed set of toolbars.

Supported aspects include any of the forgoing computer-implemented methods, wherein the new content is presented in the drilled-in command surface as sliding in from the right in response to execution of the command button.

Supported aspects include any of the forgoing computer-implemented methods, wherein the original content is redisplayed in the original command surface as sliding in from the left in response to execution of the back button.

Supported aspects include any of the forgoing computer-implemented methods, further comprising: disabling a title section of the original command surface; and presenting a new title section that includes the back button and a new title to be displayed upon drill-in navigation.

Supported aspects include any of the forgoing computer-implemented methods, further comprising: dismissing the original command surface in response to touch user input that is outside of the original command surface.

Supported aspects further include an apparatus, a system, a computer-readable storage medium, and/or means for implementing and/or performing any of the foregoing computer-implemented methods or portions thereof.

Supported aspects include a computer-readable storage medium storing computer-executable instructions that, when executed by a computing device, cause the computing device to implement a command surface drill-in control configured to: provide push functionality in response to execution of a command button in an original command surface that displays original content, wherein the push functionality pushes new content to a command surface stack that includes the original content; and provide pop functionality in response to execution of a back button in a drilled-in command surface that displays the new content and reuses on-screen real estate that was occupied by the original command surface, wherein the pop functionality removes the new content from the command surface stack causing the original content to be redisplayed by the original command surface.

Supported aspects include the foregoing computer-readable storage medium, wherein the command surface drill-in control provides animation functionality for: displaying the new content in the drilled-in command surface as sliding in from the right in response to the execution of the command button; and redisplaying the original content in the original command surface as sliding in from the left in response to execution of the back button.

Supported aspects include the foregoing computer-readable storage media, wherein the command surface drill-in control is further configured to: disable a title section of the original command surface; and present a new title section that includes the back button and a new title to be displayed upon drill-in navigation.

Supported aspects further include an apparatus, a system, a computer-implemented method, and/or means for implementing any of the foregoing computer-readable storage media or performing the functions thereof.

Supported aspects can provide various attendant and/or technical advantages in terms of improved efficiency and/or savings with respect to power consumption, memory, processor cycles, and/or other computationally-expensive resources.

The detailed description provided above in connection with the appended drawings is intended as a description of examples and is not intended to represent the only forms in which the present examples may be constructed or utilized.

It is to be understood that the configurations and/or approaches described herein are exemplary in nature, and that the described embodiments, implementations and/or examples are not to be considered in a limiting sense, because numerous variations are possible. The specific processes or methods described herein may represent one or more of any number of processing strategies. As such, various operations illustrated and/or described may be performed in the sequence illustrated and/or described, in other sequences, in parallel, or omitted. Likewise, the order of the above-described processes may be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A computing device configured to provide navigation control in an application user interface, the computer system comprising:
a processor configured to execute computer-executable instructions; and
memory storing computer-executable instructions configured to:
display an original command surface in response to execution of a command in the application user interface, the original command surface presenting original content contained in a command surface stack, the original content including a command button that is presented in the original command surface, the original command surface implementing a command surface drill-in control including push functionality for drill-in navigation and pop functionality for drill-out navigation;
invoke the push functionality of the command surface drill-in control to push new content to the command surface stack in response to execution of the command button presented in the original command surface;
display a drilled-in command surface that presents the new content contained in the command surface stack, wherein the drilled-in command surface presents a back button and reuses on-screen real estate that was occupied by the original command surface;
invoke the pop functionality of the command surface drill-in control to remove the new content from the command surface stack in response to execution of the back button presented in the drilled-in command surface; and
redisplay the original command surface that presents the original content.

2. The computing device of claim 1, wherein the command surface drill-in control associates the push functionality with the command button, implements the back button, and associates the pop functionality with the back button.

3. The computing device of claim 1, wherein:
invoking the push functionality of the command surface drill-in control pushes the new content to a top position of the command surface stack; and
invoking the pop functionality of the command surface drill-in control removes the new content from the top position of the command surface stack.

4. The computing device of claim 1, wherein the command surface drill-in control is configured to:
disable a title section of the original command surface; and
present a new title section that includes the back button and a new title to be displayed upon drill-in navigation.

5. The computing device of claim 1, wherein command surface drill-in control includes animation functionality to present the new content in the drilled-in command surface as sliding in from the right in response to execution of the command button.

6. The computing device of claim 1, wherein command surface drill-in control includes animation functionality to present the original content in the original command surface as sliding in from the left in response to execution of the back button.

7. The computing device of claim 1, wherein the command in the application user interface is executed in response to touch input into a ribbon on a toolbar command button.

8. The computing device of claim 1, wherein the new content includes one or more additional commands related to the command button in the original command surface.

9. The computing device of claim 1, wherein the memory further stores computer-executable instructions configured to:
dismiss the original command surface in response to touch input that is outside of the original command surface.

10. A computer-implemented method performed by a computing device to provide navigation control in an application user interface, the computer-implemented method comprising:
displaying, in the application user interface, an original command surface that presents original content contained in a command surface stack, the original content including a command button, the original command surface implementing a command surface drill-in control including: push functionality associated with the command button, a back button, and pop functionality associated with the back button;
pushing new content to the command surface stack by invoking the push functionality of the command surface drill-in control in response to execution of the command button presented in the original command surface;
displaying a drilled-in command surface that presents the new content contained in the command surface stack, the drilled-in command surface presenting the back button and reusing on-screen real estate that was occupied by the original command surface;
removing the new content from the command surface stack by invoking the pop functionality of the command surface drill-in control in response to execution of the back button presented in the drilled-in command surface; and
redisplaying the original content in the original command surface.

11. The computer-implemented method of claim 10, wherein the command surface stack is a last-in-first out stack.

12. The computer-implemented method of claim 10, wherein the original command surface is initially displayed in response to execution of a command in a user interface surface of the application user interface.

13. The computer-implemented method of claim 12, wherein the user interface surface is a ribbon comprising a tabbed set of toolbars.

14. The computer-implemented method of claim 10, wherein the new content is presented in the drilled-in command surface as sliding in from the right in response to execution of the command button.

15. The computer-implemented method of claim 10, wherein the original content is redisplayed in the original command surface as sliding in from the left in response to execution of the back button.

16. The computer-implemented method of claim 10, further comprising:
disabling a title section of the original command surface; and
presenting a new title section that includes the back button and a new title to be displayed upon drill-in navigation.

17. The computer-implemented method of claim 10, further comprising:
dismissing the original command surface in response to touch user input that is outside of the original command surface.

18. A computer-readable storage medium storing computer-executable instructions that, when executed by a computing device, cause the computing device to implement a command surface drill-in control configured to:
provide push functionality in response to execution of a command button in an original command surface that displays original content, wherein the push functionality pushes new content to a command surface stack that includes the original content; and
provide pop functionality in response to execution of a back button in a drilled-in command surface that displays the new content and reuses on-screen real estate that was occupied by the original command surface, wherein the pop functionality removes the new content from the command surface stack causing the original content to be redisplayed by the original command surface.

19. The computer-readable storage medium of claim 18, wherein the command surface drill-in control provides animation functionality for:
displaying the new content in the drilled-in command surface as sliding in from the right in response to the execution of the command button; and
redisplaying the original content in the original command surface as sliding in from the left in response to execution of the back button.

20. The computer-readable storage medium of claim 18, wherein the command surface drill-in control is further configured to:
disable a title section of the original command surface; and
present a new title section that includes the back button and a new title to be displayed upon drill-in navigation.
